(19) United States
(12) Patent Application Publication
(10) Pub. No.: US 2009/0033604 A1
(43) Pub. Date: Feb. 5, 2009

(54) Hybrid Display

(75) Inventors: Aris K. Silzars, Sammamish, WA (US); Gary E. Thomas, Eindhoven (NL)

Correspondence Address: SUTHERLAND ASBILL & BRENNAN LLP, 999 PEACHTREE STREET, N.E., ATLANTA, GA, 30309, US

(73) Assignee: NANOLUMENS AQUISITION, INC., Norcross, GA (US)

(21) Appl. No.: 11/832,786

(22) Filed: Aug. 2, 2007

(51) Int. Cl. G09G 3/34

(52) U.S. Cl. 345/84

(57) ABSTRACT

In one embodiment, a hybrid display that may include a first light emitter of a first type and a second light emitter of a second type that define first and second addressable subpixels of a hybrid pixel. The first and second light emitters may be coupled to a support and provided with drive means for emitting light. The hybrid subpixels may be arranged in a variety of formats to provide a desired emission of light from the hybrid pixel. The support may be flexible to provide a flexible hybrid display. A dummy subpixel may be provided for spacing or to allow for transmission of light from another light emitter and light guides may be provided for guiding light to the dummy subpixel.

### FIELD OF THE INVENTION

The present invention relates to displays, and more particularly to a flexible display with improved performance.

### BACKGROUND

A variety of different display technologies have been developed, such as liquid crystal display (LCD), plasma, organic or polymeric light emitting diodes (LED), thick film dielectric electroluminescent (TDEL), and thin film electroluminescent (TFEL) technologies, to name a few. Each display technology has its own advantages and disadvantages. For example, while plasma-based displays provide the advantages of high brightness, large viewing angle, and thin, light weight structures, they tend to require large amounts of power and are susceptible to burn-in. LCD-based displays offer compact size and large viewing angles but are delicate and subject to trailing-effects when showing motion.

Both LCD and plasma displays are rigid, relying on glass substrates. These rigid displays have some drawbacks. First, LCD and plasma displays do not lend themselves to scalability due to weight, cost, manufacturing, and efficiency issues. Rigid displays do not offer the advantages of flexible displays. For example, flexible displays offer safety advantages over rigid displays when used in particular applications, such as their use in motor vehicles. In addition, unlike the aforementioned plasma and LCD displays, flexible displays can be folded or rolled into different shapes and sizes thereby facilitating their transport and use. The manufacture of flexible displays with flexible substrates offers the promise of low-cost and high volume-production techniques, such as roll-to-roll processing.

Another type of display, thin film electroluminescent (TFEL), offer the advantages of robustness, long life, wide operating temperature range, high contrast, wide viewing angle, high brightness and low power. TFEL devices typically include a laminate or laminar stack of thin films deposited on a substrate; wherein the laminate comprises an EL phosphor material and an insulating layer sandwiched between a pair of electrode layers. A recent breakthrough in TFEL technology is the development of EL die-based technologies in which EL dice, similar to semiconductor dice, are incorporated into a flexible substrate to produce a flexible display. The dice can be of varied shapes and sizes. For example, U.S. Patent Application Publication No. 2007/069642, which is incorporated by reference herein in its entirety, discloses a flexible display in the form of a Sphere-Supported Thin Film EL (SSTFEL) device, and U.S. patent application Ser. No. 11/526,661, which is also incorporated by reference in its entirety herein, discloses an EL chip-based flexible display.

As known by those of skill in the art, most color displays are made up of pixels, which are in turn made up of subpixels, typically red, green, and blue subpixels. The intensity of the different colored subpixels is manipulated to generate a desired color. While the aforementioned EL die-based display technologies provide the advantages associated with flexible displays, the absence of a bright blue phosphor has heretofore hindered the development of a full color flexible display. A red phosphor of high brightness, such as that disclosed in U.S. patent application Ser. No. 10/552,452 and incorporated herein in its entirety, and a green phosphor of high brightness, such as that disclosed in U.S. Pat. Nos. 5,897,812 and 5,725,801 which are hereby incorporated by reference herein in their entirety, have been developed which provide luminance levels acceptable for use in a high brightness display. Other phosphors known in the art provide emission over all wavelengths of visible light. The development of a corresponding blue phosphor of high brightness for use as a blue EL subpixel has proven more elusive. For example, while the aforementioned red and green phosphors may provide luminance levels in the range of 75 and 377 cd/m², respectively, blue phosphor, such as that disclosed by Planar in U.S. Pat. No. 6,242,858, provides luminance levels in the range of 20 to 35 cd/m².

Attempts have been made to improve the brightness of TFEL-based displays, including the use of overlapping TFEL-based subpanels. For example, U.S. Pat. No. 4,801,844 entitled “Full Color Hybrid TFEL Display Screen” discloses a “hybrid” full color TFEL display device that includes a pair of independently addressable matrix arrays on stacked substrates wherein the front substrate includes patterned phosphors arranged as alternating stripes, and the rear substrate includes a single phosphor layer. The rear phosphor layer may be either a red or blue emitter and the front phosphor stripes are either red-green or blue-green. The space between the stacked substrates may be filled with a dyed filler material to improve the chromaticity of the rear substrate phosphor. To achieve a full color spectrum the fill factors of the various phosphors are adjusted to be inversely proportional to respective luminance of each at the driving frequency of the panels. The rear display panel may include the blue phosphor SrS:CeF₃.

Others have attempted to provide displays of improved brightness by taking advantage of the manner by which humans perceive light. The human eye includes a plurality of photoreceptors called cones that are used for daylight and color vision. The eye has many more red and green cones than blue cones; and therefore people see blue in a lower resolution. Techniques to increase the brightness of a display by exploiting this phenomenon include providing a specific pixel arrangement and/or decreasing the number of blue pixels/subpixels in relation to green and blue subpixels. As discussed in U.S. Pat. No. 6,714,206, Clairvoyante has developed Pentile® technology that provides specific subpixel/pixel arrangements to provide a display of increased brightness. These pixel arrangements are often referred to as “tiling.” One example of tiling is known as split stripe tiling, in which green and red stripes are split in two to form five subpixels: two vertically aligned green subpixels, two vertically aligned red subpixels and one blue subpixel positioned between the red and the green subpixels, in lieu of a standard Red Green Blue (RGB) striped pixel having three subpixels, one of each color. Another technique, referred to as “Pentile tiling,” exchanges the position of a red and green subpixel of the split stripe pixel so that subpixels of the same color are diagonally aligned instead of vertically aligned. In addition, non-rectangular shaped subpixels can be used.

While these prior art techniques provide displays of increased brightness they typically use a single light emitting technology and therefore are limited by the characteristics of the particular light-emitting technology employed. Furthermore, these prior art displays are not flexible. What is needed is a flexible display of high brightness and acceptable color gamut that is easily manufactured.

### SUMMARY OF THE INVENTION

The present invention provides a hybrid display in which two or more light emitting technologies are used. In one aspect of the invention, a hybrid display comprises a pixel arrangement that includes at least one subpixel comprising a light emitter of a first emissive technology and at least one subpixel comprising a light emitter of a second emissive technology. These emissive technologies may include but are not limited to OLED, PLED, TDEL, TFEL, plasma tubes or cells, quantum dots, and others known in the art. In one exemplary embodiment of the invention, at least one EL die-based subpixel is combined with at least one LED-based subpixel to form a hybrid pixel arrangement. For example, an EL-chip based subpixel and/or a SSTFEL subpixel may be used in conjunction with an LED-based subpixel to form a hybrid pixel. A plurality of the hybrid pixels may be arranged to form a hybrid display.

The first and second type subpixels, and the corresponding hybrid pixels which they form, may be incorporated into a hybrid display in a variety of ways. In one exemplary embodiment, the first and second type light emitters which make up the subpixels are incorporated into a single flexible substrate. For example, red and green EL spheres or chips and blue LEDs may be arranged on a flexible substrate in an RGB pattern to define red, green and blue subpixels which together define a hybrid display pixel. A plurality of hybrid pixels may be arranged to provide a hybrid display.

The EL chips and LEDs may be incorporated into a flexible substrate by attaching them with a conductive adhesive, by embedding them into a flexible substrate (as disclosed in U.S. patent application Ser. No. 10/570,516 and U.S. patent application Ser. No. 11/526,695), or otherwise incorporated them into a flexible substrate. The first type subpixels may be arranged in a row and column matrix and row and column conductors may be provided to the first type subpixels to form a matrix addressable array of first type subpixels. A first drive means for driving the first type subpixels may also be provided. Second type subpixels may also be arranged in an array of rows and columns, and row and column conductors provided to the second type subpixels along with a second drive means for driving the second type pixels. A controller may be provided for controlling the first and second drive means so that there is a desired emission of light from the first and second type emitters. The first and second type light emitters may then be driven to emit light having desired characteristics.

The first and second type light emitters may be arranged in a variety of different pixel architectures. In an exemplary embodiment, a standard RGB pixel arrangement may be provided in which red, green and blue subpixels of different emitter types are provided in a 1:1:1 ratio to form a hybrid RGB pixel. For example, a red SSTFEL light emitter, a green EL-chip light emitter, and a blue LED light emitter may be arranged to form an RGB hybrid pixel of three different light emitter types. In alternative arrangements, other ratios and other light emitter technologies may be used, such as providing a first type light emitter in conjunction with multiple subpixels of a second type light emitter. For example, red and green EL light emitter dice may be provided in rows and columns and grouped together into a RG grouping of adjacent red and green EL emitter dice. A first drive means may be associated with the RG groupings to form a matrix-addressed RG subpixel grouping. A second type light emitter, such as a blue LED, may be provided and associated with one or more RG subpixel groupings. For example, in the case where the luminance value of the second type emitter is sufficiently high, the blue LED emitter may be associated with multiple RG subpixels groupings. A second drive means may be associated with the blue LED, and the emission of light from the RG subpixels and the blue LED emitter coordinated, so that the blue LED and its associated RG groupings to which it is assigned, define a virtual hybrid pixel, where one blue LED is constructed and operated to replace any number of blue subpixels.

A controller may be provided for controlling the first and second drive means, the controller receiving data signals from a signal source and providing control signals to the first and second drive means to generate desired emissions from the various subpixels.

In an alternative embodiment, a hybrid sub-panel arrangement may be used to incorporate first and second type subpixels into a display. For example, a first sub-panel may be provided with first type subpixels of a first light-emitting technology, such by way of example and not limitation, SSTFEL spheres or EL chips. A second sub-panel may be provided with second type subpixels of a second light-emitting technology, such as by way of example and not limitation, LED. The first and second subpanels may then be overlaid to provide a hybrid display incorporating both first and second type emitters.

In addition to light emitter subpixels, dummy subpixels may also be used in a hybrid display of the present invention. A dummy subpixel may be a physical structure or a spacing between subpixels through which light may be transmitted from another source. For example, a dummy subpixel may be provided which itself does not emit light but may be placed in front of a light emitter so that the emitted light is transmitted through the dummy subpixel. Thus, a red-green-dummy (RGD) subpixel arrangement may be provided and given a first drive means for producing light emission from the red and green subpixels. The dummy RGD pixel may then be associated with a blue subpixel to define an RGDB pixel. For example, a blue LED may be placed behind the dummy subpixel, on the same or a separate panel, so that light emitted from the blue LED is transmitted through the dummy subpixel.

The dummy subpixel may assist in the proper spacing of the light emitter subpixels, such as when the light emitters are attached or embedded into a flexible substrate. For example, a dummy subpixel may occupy one of the subpixel locations of a pixel. An RGD pixel subpanel may be used in conjunction with a rear blue subpixel subpanel to create a panelized color display.

In addition to first and second type light emitters, a hybrid display of the present invention may further include one or more drive units for driving the light emitters. For example, a hybrid display system may include a first drive circuit to drive a first subpanel having first type light emitters and a second drive circuit to drive a second subpanel having second type light emitters. A controller may also be provided to control the first and second drive circuits so that desired light emission is achieved from the various first and second type light emitters.

An exemplary apparatus of the present invention comprises: a first flexible sub-panel, said sub-panel having an addressable matrix array arrangement of emissive dice of a first emissive type; a second flexible sub-panel, said second sub-panel having an addressable matrix array arrangement of emitters of a second type; and a controller for coordinating emission from said first subpanel and said second subpanel.

A system of the present invention may include a first drive system for driving the light emitters of a first technology; a second drive system for driving the light emitters of the second technology; and a controller adapted to control the first and second drive systems.

The present invention allows for the use of different type light emitter technologies to be used in a single display, thereby providing the ability to exploit the advantages of each light emitting technology. For example, by employing the SSTFEL or EL chips on a flexible substrate, lightweight, high brightness, and flexible characteristics are provided. By employing LEDs, increased brightness is provided without the large power demands of a full-color LED display. Furthermore, because fewer LEDs can be used to achieve the same level of brightness as a number of EL based subpixels, the driving of the LED is simplified and the power consumption of the display is decreased.

In accordance with one aspect of the invention, different types of light emitters may be used and provided with different drive means. Furthermore, different hybrid and pixel architectures may be provided depending upon the desired display characteristics. For example, in some layouts where a first type light emitter, such as a red SSTFEL die, produces luminance levels in a first range, and a second type light emitter, such as a blue LED emitter, produces luminance in a second range, one blue emitter may be assigned to multiple RG groupings to form a virtual hybrid pixel.

Various methods may be used to determine the desired intensity of light to be emitted by each light emitter, such as the pixel size, the luminance of the light emitter, the sensitivity of the human eye to the particular light emitted, etc. Furthermore, virtual pixels may be defined which include a plurality of physical subpixels or subpixel groupings that may be driven to produce a desired light emission. Where a single element of a first type light emitter is assigned to a plurality of physical pixels, various methods can be used to determine the intensity level of the first light emitter. For example, a desired value of a first light emitter may be determined for each physical pixel grouping to which the first light emitter is assigned, and the determined values averaged to determine the intensity value for the first light emitter. For example, where a blue LED is assigned a virtual pixel that includes three RG groupings, an intensity value for a blue subpixel for each grouping can be determined, and the average of these three values may be used to assign the final value of the blue LED. In one exemplary arrangement the subpixels are arranged so that green light emitters provide 50% of the brightness, red light emitters 35%, and blue 15%. Because different light emitting technologies are used, the ratio of the physical subpixels may be significantly different than a 50%-35%-15% arrangement. In an exemplary embodiment, the desired intensity for each grouping can be determined by a variety of methods, which may depend upon the particular application of the display. Thus, in this case where fewer blues are used, each red and green subpixel grouping may be addressable at the RG physical pixel level and the blue LED at the virtual pixel level.

The value of the blue LED may vary depending upon the desired brightness, color point, resolution, and setting of the display. Furthermore, because the human eye has less blue resolution, blue emitters may be provided at a lesser density than red or green emitters, and the intensity level determined accordingly. In the exemplary embodiments discussed herein, the subpixels are approximately the same size; however, the sizes of the light emitters may be adjusted in accordance with particular performance characteristics. For example, subpixels of lower luminance per area may be provided in larger sizes to provide increased brightness.

Because the first and second type light emitters may have different performance characteristics and different driving characteristics, separate drive means may be provided for each type of light emitter. A first drive means may include row and column conductors and a power source adapted to drive said first type subpixels. A second drive means may include row and column electrodes and a power source for driving said second type subpixels. The row conductors may be provided in parallel fashion to prevent interference between the row conductors. A column conductor may be provided on the front of the first type light emitter subpixels and may be transparent such as ITO. A rear column driver may be provided to the second type light emitting dice. For example, a column conductor may include leads which extend from a conductor conduit which includes an insulating casing to prevent interference with other conductors. Leads may extend from the second type light emitter to conductively couple the second type emitter to the column conductor. Matrix addressing may therefore be provided to both the first and second type light emitter subpixels. An additional structure and method for electrically connecting the first and second type light emitter subpixels to first and second drive means is the use of single-sided electrical contacts as described in U.S. patent application Ser. No. 11/683,489, which is hereby incorporated by reference in its entirety.

An exemplary method of the present invention comprises: providing a first type emissive die on a support; providing a second type emissive die on the support; providing a first drive means to the first emissive die; and providing second drive means to the second emissive die, the first and second emissive dice forming a hybrid pixel. The method may further comprise providing a dummy subpixel to the support. The dummy subpixel may be a structure, a space, or an aperture and may include various light manipulation features, such as diffuser, light tube, color filter, etc. In an example of the invention the support is flexible to provide a flexible hybrid display. The emissive dice may emit light having different characteristics. For example, the emissive dice of a first type may emit red or green light and the second type emissive dice may emit blue light. The emissive dice may be arranged in a variety of arrangements such as by way of example and not limitation, red-green-blue (RGB), red-green-dummy (RGD), red-green-red-green-blue (RGRGB). In addition, a third light emitter may be provided which may be of a third type or of the first or second type.

Another method of the present invention comprises: providing a first flexible sub-panel, said sub-panel having an addressable matrix array arrangement of emissive dice of a first emissive type; providing a second flexible sub-panel, said second sub-panel having an addressable matrix array arrangement of emitters of a second type; and coupling the first flexible sub-panel and said second flexible sub-panel so that the emissive dice of said first and second sub-panels.

Another method of the invention includes determining a desired characteristic of a hybrid pixel; determining a characteristic of light to be emitted from a first subpixel of the hybrid pixel; sending a drive signal to the first subpixel to emit the desired light; determining a characteristic of light to be emitted from a second subpixel of the hybrid pixel; and sending a drive signal to the second subpixel of the hybrid pixel.

### BRIEF DESCRIPTION OF THE DRAWINGS

FIG. 1A shows a hybrid display in accordance with an exemplary embodiment of the invention employing EL die-based emitters and LED emitters.

FIG. 1B shows an enlarged view of the display of FIG. 1A, along section 1B-1B.

FIG. 2 shows a hybrid pixel arrangement in accordance with an exemplary embodiment of the invention.

FIG. 3A shows a hybrid pixel arrangement in accordance with an exemplary embodiment of the invention.

FIG. 3B shows a hybrid pixel arrangement in accordance with another exemplary embodiment of the invention.

FIG. 4 shows an EL die-based emitter in accordance with an exemplary embodiment of the invention.

FIGS. 5A & 5B show an LED emitter in accordance with an exemplary embodiment of the invention.

FIG. 6 shows EL die-based emitters and an LED emitter on a flexible substrate in accordance with an exemplary embodiment of the invention.

FIG. 7 shows another subpixel arrangement in accordance with an exemplary embodiment of the invention.

FIG. 8 shows a panel-type hybrid display in accordance with an exemplary embodiment of the invention.

FIG. 9 shows a hybrid display incorporating a SSTFEL based sub-panel and an LED based subpanel in accordance with an exemplary embodiment of the invention.

FIG. 10 shows a schematic of a hybrid display in accordance with an exemplary embodiment of the invention.

FIG. 11 shows an exemplary method of the invention.

FIG. 12 shows an exemplary method of the invention.

### DETAILED DESCRIPTION

As required, exemplary embodiments of the present invention are disclosed herein. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

For purposes of teaching and not limitation, the exemplary embodiments disclosed herein are discussed mainly in the context of EL die-based light emitter technologies such as SSTFEL and EL chip technologies that are used in conjunction with LED light emitters to form a hybrid display. However, the present invention is applicable to other light emitting technologies as well, such as, by way of example and not limitation, Organic Light Emitting Diodes (OLED), Polymeric Light Emitting Diodes (PLED), quantum dot, thick film dielectric electroluminescent (TDEL), thin film electroluminescent (TFEL), and plasma tubes or cells. The light emitter types may be different forms of the same base technology; for example, EL chip and SSTFEL emitters, both are forms of TFEL, may be the first and second type emitters.

Furthermore, for purposes of teaching and not limitation, the exemplary embodiments of the hybrid displays are shown incorporating two light emitter types. But more than two different light emitter types may be incorporated into a hybrid display of the present invention. For example, a red emitter could be in the form of an EL chip, a green emitter in the form of a SSTFEL emitter, and a blue emitter in the form of an LED. Furthermore, multiple drive means may be used, such as a first, second, and third drive means for driving the first, second, and third emitter types, respectively.

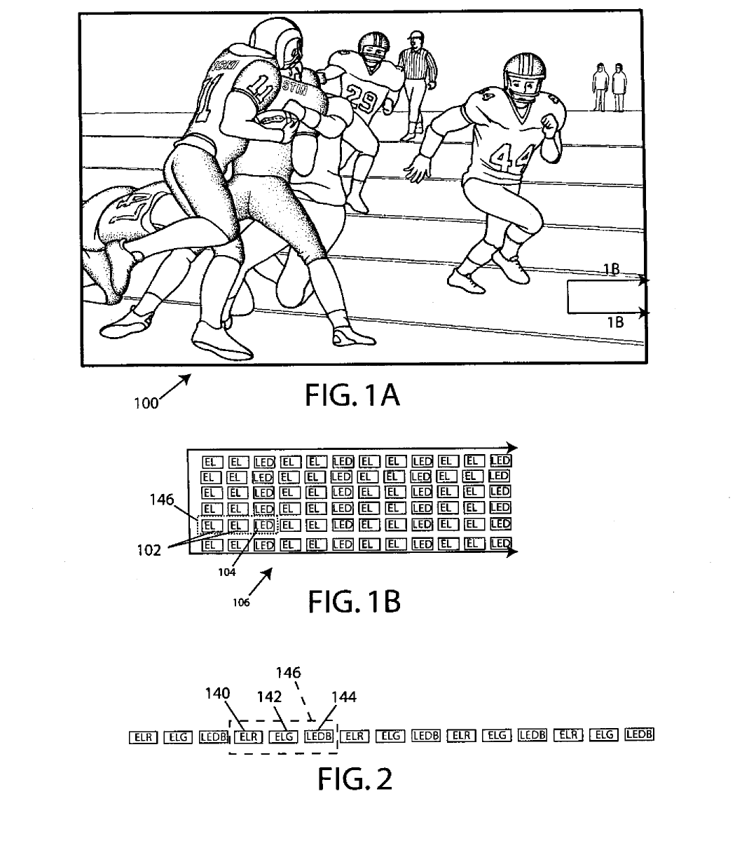

Turning to the figures, wherein like numbers represent like features throughout the several views, FIG. 1A shows a hybrid display 100 in accordance with an exemplary embodiment of the invention. The display 100 includes a plurality of first-type light emitters and a plurality of second-type light emitters which work together to provide a hybrid display of improved performance. In the exemplary embodiment shown in FIG. 1B, the first-type light emitters are in the form of EL chips 102, also referred to as nixels, and the second-type light emitters are in the form of LEDs 104. The first and second-type emitters are arranged in a predetermined pattern 106 and define first and second type subpixels. The intensity of the different subpixels can be varied to provide a desired gray scale or color. For example, as shown in FIG. 2, the EL emitters 102 may include red and green phosphors and define red 140 and green 142 subpixels, respectively. Likewise, the LED light emitters 104 may emit blue light and define a blue subpixel 144.

The first 140, 142 and second 144 type subpixels together define a pixel 146 of the display 100. For example, the red 146, green 142, and blue 144 subpixels may be arranged to form an RGB pixel 146. A plurality of RGB pixels 146 may be arranged to define a color display. In the exemplary embodiment shown in FIG. 2, a standard RGB format is used in which adjacent single red, green, and blue subpixels are grouped to together to form a pixel 146.

The pixel 146 may be driven by supplying the individual subpixels 140, 142, 144 with a sufficient threshold voltage to cause light emission. The voltage may be manipulated to vary the intensity of light of the different subpixels 140, 142, 144 so that the combination of light emitted produces light of desired characteristics.

As discussed in more detail below, different subpixel and pixel arrangements may be provided depending upon the desired characteristics of the display. For example, where a SSTFEL light emitter is used for red and green light emitters, the luminance of the red and green pixels may be in the range of 75 cd/m² and 377 cd/m² respectively. A blue emitter comprising an LED having a luminance of several thousand cd/m² may also be used. Because of the greater luminance of the blue LED emitter, and the human eye's lower resolution of blue, a desired subpixel arrangement may include different ratios of blue subpixels to red and green subpixels. For example, a blue emitter may be assigned to multiple red and green subpixels.

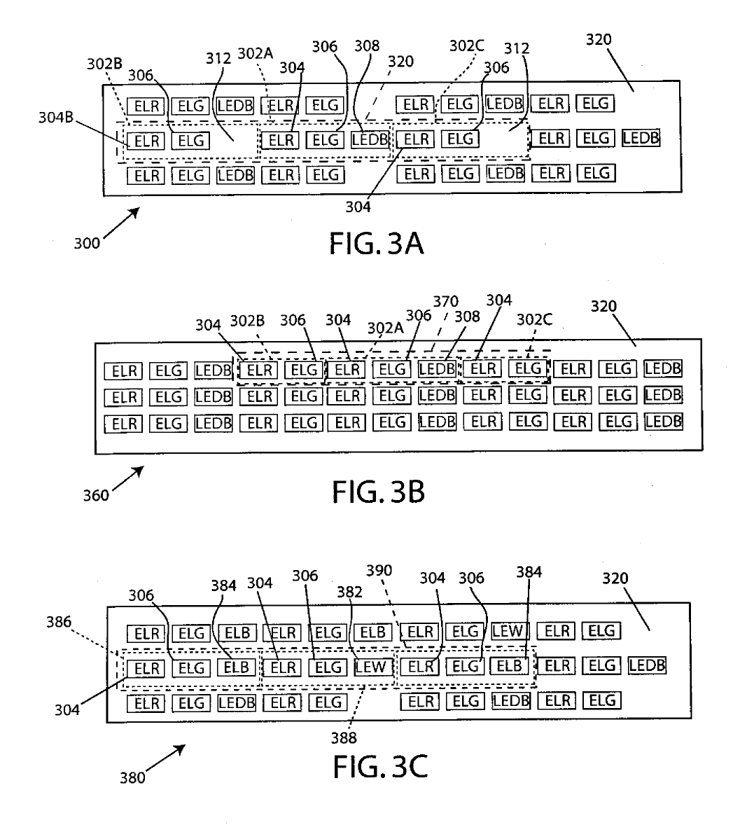

As shown in FIG. 3A, a hybrid display 300 includes a plurality of pixels 302 provided on a flexible substrate 320. A first pixel 302A may include red EL subpixel 304, a green EL subpixel 306, and a blue LED subpixel 308 which together define a RGB pixel 302A. Second 302B and third 302C pixels located on opposite sides of the RGB pixel 302A, may include a red EL subpixel 304 a green EL subpixel 306 and, in lieu of a blue subpixel 308, a space 312 and together form RGS pixels. Because the blue LED has high brightness and the human eye sees blue in lower resolution, the blue subpixels may be provided at a lower density in the display. In this case, a blue LED light emitter is provided for every third RG pixel grouping. Thus, the RGB pixel 302A and the RGS pixels 302B, 302C together define a blue virtual pixel 320 to which the blue subpixel is assigned. In other words, the blue subpixel 308 provides blue light for pixels 302A-C. The red 304 and green subpixels 306 of the pixels 302A-C may be driven by a first drive means (not shown) and the blue subpixels 308 driven by a second drive means (not shown) as discussed in more detail below. As also discussed in more detail below, instead of including a space 312 in the RG subpixels, a dummy subpixel (not shown) may be provided to form RGD pixels, or the subpixels may be more closely packed so that the green subpixel 306 of the second pixel 302B is adjacent to the red subpixel 304 to form a RG pixel and together form a virtual RGRGB pixel 370 as shown in the hybrid display 360 of FIG. 3B. Other arrangements are also possible, such as the hybrid display 380 shown in FIG. 3C in which white LEDs 382 are interspersed with red 304, green 306, and blue 384 EL subpixels to form a virtual pixel 390. Other arrangements using different light emitters are contemplated and will become apparent to those of skill in the art upon reading this disclosure. A first pixel 386 includes red 304, green 306, and blue 384 EL chips that serve as red, green, and blue subpixels. A second pixel 388 is a hybrid pixel that includes red 304 and green 306 EL chips that serve as red and green subpixels and a white LED 382 that serves as a white subpixel.

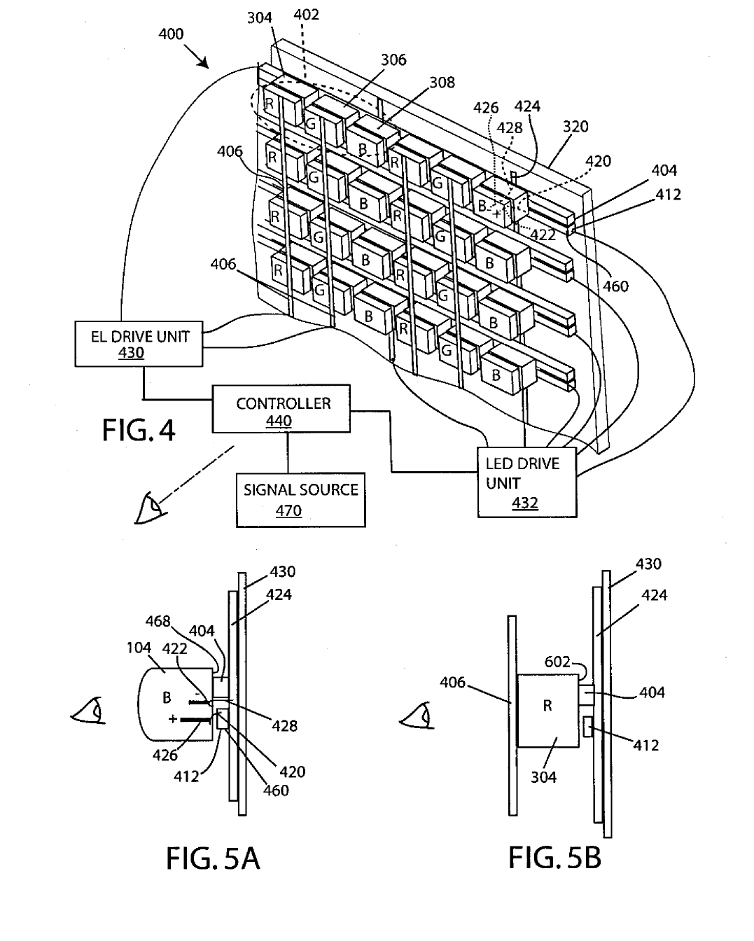

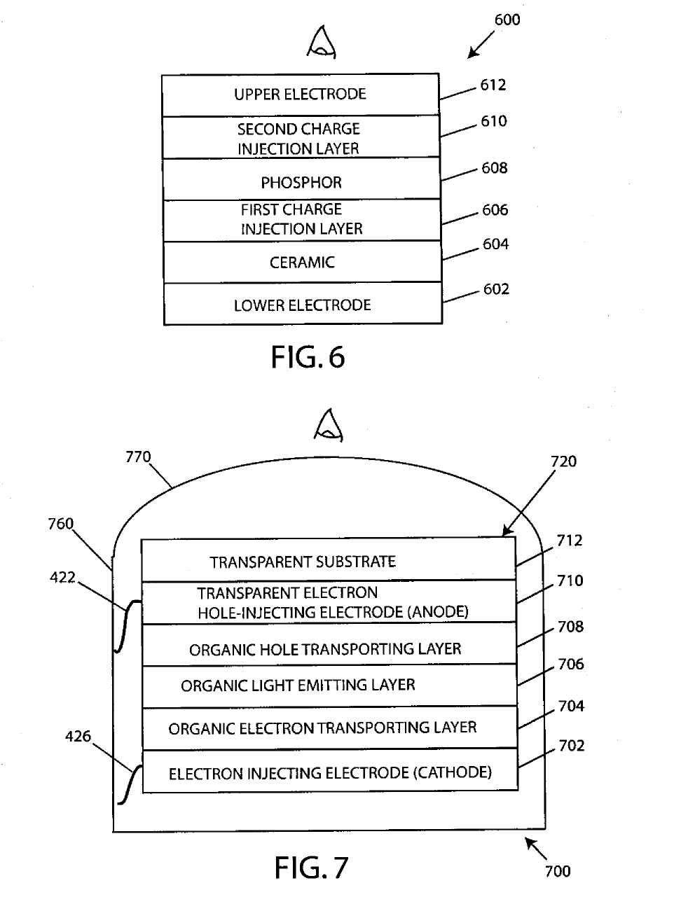

FIG. 4 shows a hybrid display 400 with an RGB pixel 402 arrangement in which red 304 and green 306 EL chip emitters define red and green subpixels. The EL chips 304, 306 are arranged in rows and columns to form a matrix array. The EL chip emitters 304, 306, referred to herein as nixels 600 (FIG. 6), may be attached to a flexible substrate 320 and provided with appropriate drive means to emit light. For example, row conductors 404 may be coupled to a rear or lower electrode 602 on the EL chips 304, 306 and column conductors 406 coupled to a front or upper electrode 612 (FIG. 6) of the EL chips 304, 306 to form a matrix-addressed EL display of red and green subpixels. Preferably, the column conductors 406 are made of a transparent conductive material, such as indium tin oxide (ITO), to allow for transmission of light from the EL chips through the conductors 406. A scanning voltage may be applied to the row conductors 404 and a data voltage to the column conductors 406 so that the area of overlap of the conductors 404, 406 receives a sufficient threshold voltage for emission of light from the EL chips 304, 306. A drive unit 430 provides the necessary drive signals for driving the row 404 and column 406 conductors and may include a processor for executing required commands in accordance with a predetermined scheme. The drive unit 430 may be coupled to a controller 440 as discussed in more detail below, which may receive data signals from a signal source 470.

FIG. 6 shows an exemplary embodiment of an EL emitter or nixel 600. As disclosed in U.S. patent application Ser. No. 11/526,661, which is incorporated by reference herein in its entirety, an EL chip may include a ceramic substrate 604, a first charge injection layer 606 on an upper surface of the ceramic substrate 604, a phosphor layer 608 on top of the first charge injection layer 606, a second charge injection layer 610 on top of the phosphor layer 608, an upper electrode 612 on the upper surface of the second charge injection layer 610 and a lower electrode 602 on the lower surface of the ceramic substrate 604. In a further embodiment, the first and/or second charge injection layer(s) may be eliminated. The upper electrode 612 and lower electrode 602 may be coupled to column 406 and row 404 conductors of the display to allow for the drive unit 406 to provide the desired voltages to generate light emission.

In addition to the EL chips 304, 306, the hybrid pixel 402 of FIG. 4 also includes an LED 104. In this case, the LED 104 is a blue emitting LED that defines a blue subpixel of the hybrid RGB pixel 402. A plurality of LEDs 104 may be arranged in rows and columns to form a matrix array of blue LED emitters 104. In the embodiment shown in FIG. 4, one blue LED 104 is assigned to every RGB pixel 402. As discussed above and as shown in FIGS. 3A-3B, however, other arrangements of the subpixels may be provided.

Row 412 and column 424 conductors are provided for powering the LEDs 104 In this exemplary embodiment, both the row 412 and column 424 conductors may include contacts 420, 428 that are adapted to establish electrical contact with leads 422, 426 extending from the LEDs 104. Preferably, the EL row conductor 404 and the LED row conductor 412 are in a parallel spaced-apart relationship to prevent overlapping and interference. The LED row conductor 412 may be housed in an insulative cover 460 to prevent electrical contact with the EL conductors 404. The cover 460 may include apertures through which the contacts 420 protrude to contact the leads 422 of the LEDs 104.

Column conductors 424 may also be provided at the rear of the LEDs 104 to drive the LED columns. The rows and columns of LEDs 104 thereby form a matrix addressable LED arrangement. Similar to the LED row conductors 412, the LED column conductors 424 may be housed within an insulative cover 460 to prevent electrical contact with the EL conductors and the LED row conductors.

FIG. 5A shows a side view of a blue LED emitter 104 attached to a flexible substrate 430. The LED emitter includes leads 422, 426. EL row conductor 404 and LED row conductor 412 extend behind the LED emitter in parallel fashion. A contact 420 extends through the insulative cover 460 from the LED row conductor 412 to make electrical contact with the anode lead 426 of the LED emitter 104. The LED column conductor 424 extends vertically along the rear of the LED emitter 104. A contact 428 extends from the column conductor 424 to make electrical contact with the anode lead 422 of the LED emitter 104. The rear surface 468 of the LED emitter 104 is preferably non-conductive so as not to interfere with the EL row conductor 404. The contacts may take various forms such as compression contacts, fuzz buttons, other electrical dry mount contacts or similar devices. The LED row 412 and column 424 conductors could be provided behind the flexible substrate 430 and access leads of the LEDs through vias (not shown).

FIG. 5B shows a side view of a red EL chip emitter 304. In this case the EL row conductor 404 makes electrical contact with the lower conductor 602. A transparent column conductor 406 makes electrical contact with the upper electrode 612 of the EL chip 304. The LED row 412 and column 424 conductors are provided at the rear of the EL chip 304 but no contacts 420, 428 extend to the chip 304. By providing light emitting dice on a flexible substrate, a flexible display is provided.

FIG. 7 shows an exemplary embodiment of an LED 700 used in a hybrid display 400. LEDs are known in the art and are available from many manufacturers and distributors with a variety of sizes, shapes, and brightness. The LED 700 generally includes a chip 720 that includes a first electrode 702 cathode for providing electrons, an electron transporting layer 704, an organic light emitting layer 706, an electron hole transporting layer 708, and an anode electrode 710 stacked on a transparent substrate 712. Leads 422, 426 extend from the anode 710 and cathode 702 and are adapted for engaging contacts 420, 428 of the row 412 and column 424 conductors, as discussed above. In this exemplary embodiment, the LED 700 is provided with a blue chip 720 to emit light of a blue wavelength, but other type chips could be used such as red, green, white, etc. Sourcing and sinking currents may be provided for driving the LEDs. The chip 720 that is housed within a cover 760 having a lens 770 for manipulating light emitted from the chip 720 Additional features commonly used in LEDs are not shown to prevent obscuring the invention, such as reflective layers, diffusers, and lenses.

Thus, the hybrid display 100 of the invention includes rows and columns of both EL chips 304, 306 and LEDs 104. The EL chips 104 may be driven by an EL drive unit 430 (FIG. 4), which may include a microprocessor, decoder, and other components known in the art. Similarly, the LEDs 104 may be driven by an LED drive unit 432. In order to produce a desired light emission, the EL 430 and LED 432 drive units are controlled by a controller 440. The controller 440 coordinates the driving of the subpixels of the display. The value of the red and green subpixels may be determined as known by those of skill in the art by processing a received data signal to determine the value of the subpixels to emit light of desired characteristics. By controlling the drive to each of the subpixels that make up a pixel and in turn controlling each of the pixels that make a hybrid display a user is capable of displaying a plurality of colors and light intensities.

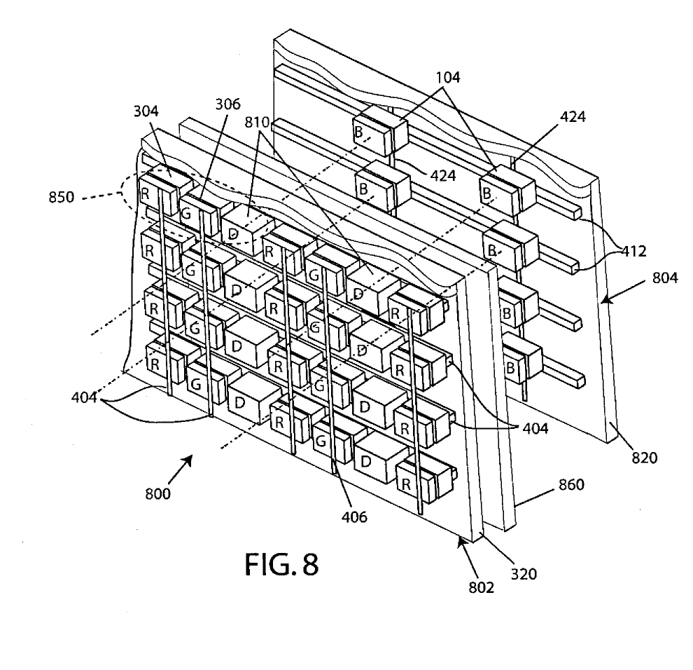

FIG. 8 shows another exemplary embodiment of a hybrid display 800 of the invention in which multiple subpanels are used. A first subpanel 802 is in the form of an EL chip matrix array including red 304 and green 306 EL chips similar to those discussed above, that act as red and green display subpixels. Dummy subpixels 810 are also provided to form a RGD pixel grouping 850. The dummy subpixels 810 are preferably transparent structures that allow the passage of light from other light sources, such as light emitted by a second sub-panel 804 provided behind the first subpanel 802. The dummy subpixel 810 may comprise a glass, plastic, polymer, or other suitable material and may also include filters, diffusers or other light output manipulators. The dummy subpixel 810 acts as a spacer between the red 304 and green 306 subpixel EL emitters and provides a path through which light from the second subpanel 804 is transmitted. Preferably the dummy subpixel 810 has a foot print similar to the size of the EL dice to provide a desired spacing between pixel groupings. The dummy subpixels 810 can thus be provided to an RG grouping in place of a blue light emitter 308 of an RGB grouping to form an RGD physical pixel 850.

A second subpanel 804 may be in the form of an LED matrix array, such as an array of blue LED emitters 104. The first 802 and second 804 subpanels may be arranged so that the blue LEDs 104 of the second subpanel 804 are aligned with the dummy subpixels 810 of the first subpanel to allow for increased transmission of light emitted from the blue LEDs 104 through the dummy subpixels 810 and provide an RGD-B pixel arrangement. A diffuser sheet 860 may be provided between the subpanels 802, 804 to assist in diffusing the light emitted from the blue LEDs. Furthermore, the sheet 860 may include various dyes for absorbing portions of the light output to otherwise manipulate the emitted light. The first 802 and second 804 subpanels may be driven by drive units (not shown) and controlled by a controller (not shown) as discussed above. In instances where a single blue LED is to provide light to multiple RGD pixels, the diffusion sheet 860 may include light paths for directing light to a plurality of dummy subpixels 810. The light paths (not shown) may take the form of channels, optical fibers, rigid or flexible plastic pieces, etc. The LEDs 104 are preferably provided on a flexible substrate 820 so that when the panels are joined to form the hybrid display 800 it is flexible. For purposes of teaching and not limitation, in FIG. 8 there is a one-to-one correspondence between the blue LED subpixel and the dummy subpixels 810 but a single LED subpixel may serve a plurality of RGD pixels. The conductors 404 may be provided in a support sheet between the subpanels.

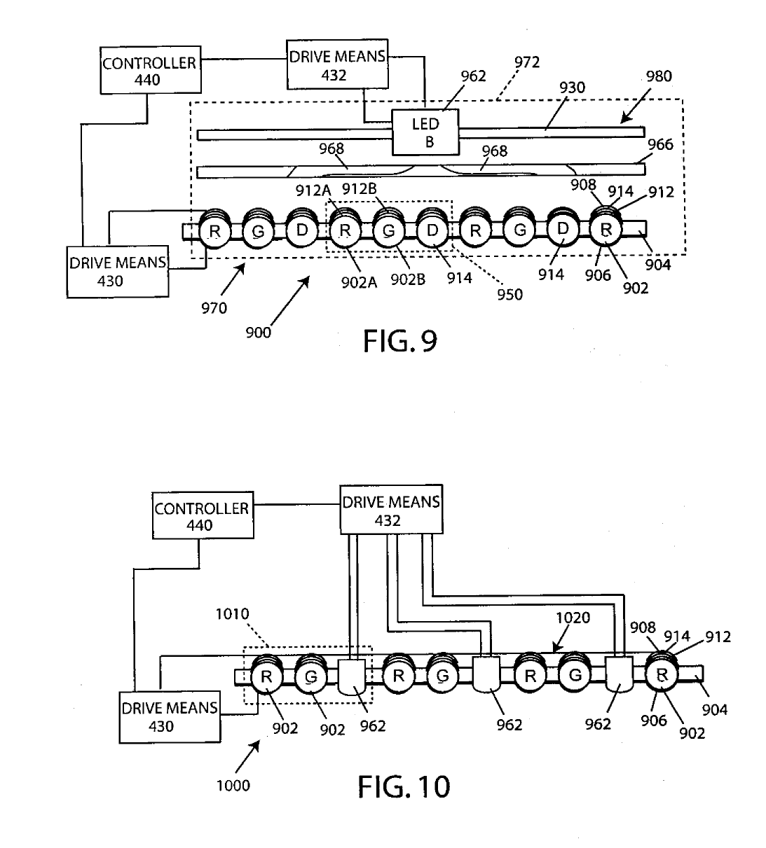

FIG. 9 shows another alternative embodiment of a hybrid display 900 of the invention in which SSTFEL spheres are used in conjunction with LEDs to provide a flexible hybrid display 900. As disclosed in U.S. Patent Application Publication No. 2007/069642, which is hereby incorporated by reference in its entirety, SSTFEL spheres 902 may be embedded in a flexible substrate 904 and provided with row 906 and column 908 electrodes to form a SSTFEL matrix addressed display 970. The spheres 902 may be provided with a phosphor layer 912, one or more charge injection layers 914, and topped with a transparent electrode layer so that a sufficient voltage provided by the top and bottom electrodes results in the emission of light from the phosphor layer 912. Different colored phosphors, such as ZnS:Mn. SrS:Cu, doped gallium oxides, BaAl₂S₄:Eu, and others known in the art, may be used and the spheres 902 may be arranged to form a color matrix. In this embodiment, the spheres may be arranged to form an RGD pixel 950 arrangement in which a first sphere 902A is provided with a red phosphor layer 912A, and a second sphere 902B is provided with a green phosphor layer 912A. A dummy subpixel 914 may also be provided. Additional layers may also be provided, such as filters and diffusers.

The dummy subpixel 914 provides a transmission path for light from a rear subpanel 980, and may be in the form of a glass sphere. The dummy subpixel 914 also provides for proper spacing between the RGD pixels 950. The rear subpanel 980 may include a second type light emitter, such as an LED 962. In this example, the LED 962 is in the form of a blue LED. The blue LED 962 provides blue light through the dummy subpixel 914. Due to the high luminance value of the blue LED a single blue LED may be assigned to a plurality of RGD physical pixels 950, which define a virtual RGB pixel 972 that includes a blue LED 962 and several RGD pixel groupings 950. First 430 and second 432 drive units may be provided as discussed above, to drive the SSTFEL spheres and the LEDs. A light guide panel 966 may be provided between the rear subpanel 980 and the front subpanel 970 and include pathways 968 for guiding light emitted from the blue LED 962 to the dummy subpixels 914.

First and second type light emitters may also be embedded into a single substrate. As shown in the hybrid display 1000 of FIG. 10, SSTFEL spheres 902 and LEDs 962 may be embedded in a flexible substrate 904 to form an EL-EL-LED pixel arrangement 1010. In this example, the LEDs 962 or dummy subpixels 914 may be provided in a single panel 1020.

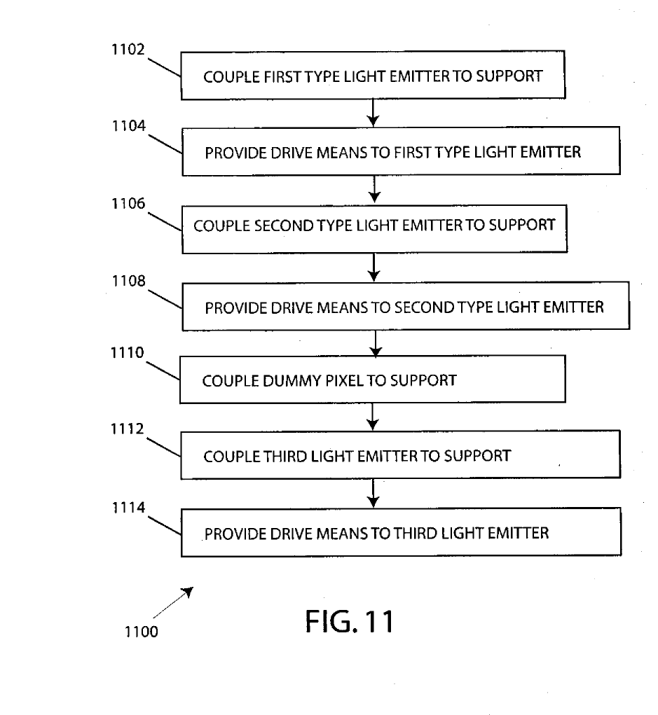

FIG. 11 shows an exemplary method 1100. At block 1102 a first type light emitter, such as red EL chips 304 and green EL chip 306 of FIG. 4, is provided to a support, such as flexible substrate 320. At block 1104 a first drive means, such as drive unit 430 may be coupled to the first type light emitter by row 404 column conductors 406. At block 1106 a second type light emitter, such as blue LED 308 of FIG. 4, may be coupled to the support 320. At block 1108 drive means, such as LED drive unit 432, may be provided to the second type light emitter 308.

At block 1110 and as shown in FIG. 8, a dummy pixel 810 may be coupled to the support 320. At block 1112 a third light emitter, such as a blue LED 104 may be provided on a second support 820 and at block 1112 a drive means 432 (FIG. 4) may be provided to the second support 820.

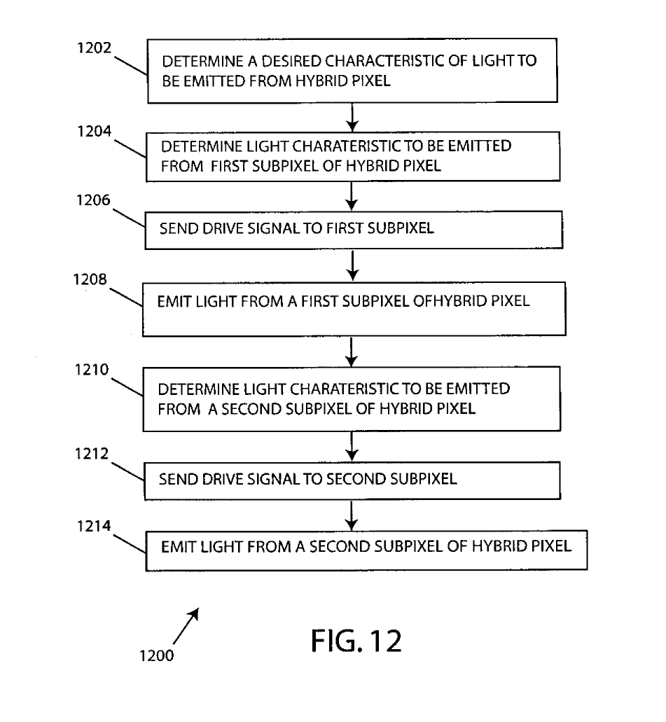

FIG. 12 shows an exemplary method 1200. At block 1202 a desired characteristic of light to be emitted from a hybrid pixel is determined. For example, data signals from a signal source 470 may be received by a controller 440 that determines the characteristics of light to be emitted from a hybrid pixel 402 (FIG. 4). At block 1204 the characteristics of a first subpixel 302 of the hybrid pixel 402 is determined. For example, for the hybrid pixel 402 of FIG. 4, the magnitude of the light to be emitted from a red EL chip subpixel 302 is determined. At block 1206 a drive signal is sent to subpixel 302, such as by providing current to row conductor 404 and column conductor 406 to generate a sufficient threshold voltage to generate the desired light from the subpixel 302 at block 1208. Likewise, light may emitted from the green light emitter 306.

At block 1210 the characteristics of a second subpixel of a second light emitter type, such as a blue LED 308 of FIG. 4. At block 1212 a drive signal may be sent to second subpixel 308 to generate light at block 1214, such as by providing current to row 412 and column 424 conductors.

What is claimed is:

1. An apparatus, comprising:
a support;
at least one first addressable light emitter coupled to said support, said first light emitter being of a first light emitter type and defining a first subpixel;
at least one second addressable light emitter, said second light emitter being of a second light emitter type and defining a second subpixel; and
wherein said first addressable light emitter and said second addressable light emitter are arranged to form a hybrid pixel.

2. The apparatus of claim 1, further comprising drive means for driving said at least one first light emitter and said at least one second light emitter.

3. The apparatus of claim 2, wherein said drive means comprises a first drive means for driving said at least one first light emitter and a second drive means for driving said at least one second light emitter.

4. The apparatus of claim 1, wherein said at least one first light emitter emits light of a first color and said second light emitter emits light of a second color.

5. The apparatus of claim 1, wherein said at least one first light emitter and said at least one second light emitter are arranged in RGB format.

6. The apparatus of claim 1, wherein said support is flexible.

7. The apparatus of claim 1, wherein said at least one first light emitter is coupled to a first subpanel and said at least one second light emitter is coupled to a second subpanel.

8. The apparatus of claim 7, wherein said first subpanel and said second subpanel are flexible.

9. The apparatus of claim 1, further comprising a third light emitter coupled to said support defining a third subpixel.

10. The apparatus of claim 9, wherein said third light emitter comprises a light emitter of a third type.

11. The apparatus of claim 1, wherein said at least one first light emitter comprises an EL chip.

12. The apparatus of claim 11, wherein said at least one second light emitter comprises an LED.

13. The apparatus of claim 1, further comprising a dummy subpixel coupled to said support.

14. The apparatus of claim 13, wherein said at least one first light emitter, said at least one second light emitter, and said dummy pixel are arranged in RGD format.

15. The apparatus of claim 1, further comprising a third light emitter coupled to a second support.

16. The apparatus of claim 1, further comprising:
a dummy subpixel coupled to said support; and
a third light emitter coupled to a second support, said third light emitter arranged to transmit light through said dummy pixel.

17. The apparatus of claim 16, further comprising a light guide to guide light from said third light emitter to said dummy subpixel.

18. The apparatus of claim 1, further comprising a controller to manipulate the drive means to cause emission of a desired light from said hybrid pixel.

19. The apparatus of claim 1, wherein said at least one first light emitter and said at least one second light emitter are arranged in an addressable virtual pixel.

20. The apparatus of claim 1, wherein said at least one first light emitter and said at least one second light emitter are arranged in a 1:1 numerical ratio.

21. The apparatus of claim 1, wherein a plurality of said first light emitters are provided for each said second light emitter.

22. The apparatus of claim 1, wherein said at least one first light emitter comprises a red light emitter and a green light emitter and said at least one second light emitter comprises a blue light emitter.

23. The apparatus of claim 22, wherein said at least one first light emitter and said at least one second light emitter are arranged in RGB format.

24. The apparatus of claim 22, further comprising at least one dummy pixel, wherein said at least one first light emitter, said at least one second light emitter, and said dummy pixel are arranged in RGDRGB format.

25. The apparatus of claim 22, further comprising:
at least one dummy pixel coupled to said support; and
at least one third subpixel coupled to a second support; wherein said at least one first light emitter, said at least one second light emitter, said at least one third light emitter, and said at least one dummy pixel are arranged in RGD-B format.

26. The apparatus of claim 1, wherein said at least one first light emitter and said at least one second light emitter are arranged to form a virtual pixel having light emitters of different types.

27. The apparatus of claim 1, further comprising a plurality of first light emitters and a plurality of second light emitters arranged to form a plurality of hybrid pixels.

28. A method, comprising:
coupling at least one first light emitter to a support, said first light emitter being of a first light emitter type and defining a first subpixel of a hybrid pixel; and
coupling at least one second light emitter to the support, said second light emitter being a light emitter of a second type and defining a second subpixel of said hybrid pixel; and
arranging said at least one first light emitter and said at least one second light emitter to form an addressable hybrid pixel.

29. The method of claim 28, wherein said support is flexible.

30. The method of claim 28, further comprising providing drive means to said at least one first light emitter and said at least one second light emitter.

31. The method of claim 28, further comprising arranging said at least one first light emitter and said at least one second light emitter in RGB format.

32. The method of claim 28, further comprising coupling at least one dummy pixel to said support.

33. The method of claim 32, further comprising arranging said at least one first light emitter, said at least one second light emitter and said at least one dummy pixel in RGD format.

34. The method of claim 28, further comprising:
coupling at least one third light emitter, said third light emitter being of a third light emitter type; and
arranging said at least one first light emitter, said at least one second light emitter, and said at least one third light emitter to form an addressable hybrid pixel.

35. The method of claim 28, wherein said at least one first light emitter comprises an EL chip.

36. The method of claim 28, wherein said at least one second light emitter comprises a LED.

37. A method, comprising;
emitting light from a first subpixel of a hybrid pixel of a display, the subpixel comprising a light emitter of a first light emitter type; and
emitting light from a second subpixel of the hybrid pixel of the display, the second subpixel comprising a light emitter of a second light emitter type.

38. The method of claim 37, further comprising:
emitting light from a third subpixel of the hybrid pixel of the display.

39. The method of claim 37, further comprising controlling light emitted from said first subpixel and said second subpixel in accordance with a desired characteristic of light emitted from said hybrid pixel.

40. The method of claim 37, further comprising:
determining a characteristic of light to be emitted from the hybrid pixel; and
sending a first drive signal to the first subpixel to emit light from the first subpixel in accordance with a desired characteristic of said hyprid pixel; and
sending a second drive signal to the second subpixel to cause emission of light from the second subpixel in accordance with the desired light emission of the hybrid pixel.
